(19) United States
(12) Patent Application Publication
(10) Pub. No.: US 2004/0184987 A1
(43) Pub. Date: Sep. 23, 2004

(54) Methods for producing pure hydrogen gas

(76) Inventors: Terry A. Ring, Sandy, UT (US); William Freise, Canyon Country, CA (US); Brett Maylett, West Valley City, UT (US); Matthew Fisher, Kaysville, UT (US)

Correspondence Address: TRASK BRITT, P.O. BOX 2550, SALT LAKE CITY, UT, 84110, US

(21) Appl. No.: 10/384,961

(22) Filed: Mar. 10, 2003

(51) Int. Cl. C01B 3/08; C01B 3/50; C01B 3/02; C10K 1/00

(52) U.S. Cl. 423/658.3; 423/657; 48/128

(57) ABSTRACT

A method for producing highly pure, hydrogen gas, of high pressure, if desired, by generating, in a reaction zone, hydrogen gas in the presence of one or more other gases and/or supercritical fluids; and the separation of at least some of the hydrogen gas by a separation zone having hydrogen selective permeability, whereby the separated hydrogen gas is substantially pure.

### BACKGROUND OF THE INVENTION

1. Field of the Invention

This invention relates to the generation and separation of hydrogen gas from mixtures which contain gases, and/or supercritical fluids.

2. State of the Art

The use of hydrogen gas to power fuel cells is receiving increased attention. The severe environmental consequences of traditional energy generation are well-established. The burning of hydrocarbon fuels produces, among other things, carbon monoxide and carbon dioxide, long identified as detrimental to the environment.

Fuel cells powered by hydrogen gas, unlike their hydrocarbon fueled counterparts, largely produce water as a byproduct. The application of hydrogen fuel cell technology to automobiles alone would greatly reduce the overall output of carbon dioxide and carbon monoxide into the atmosphere. Examples of other applications are electrical generators, gas-powered generators, and other applications which are presently fueled by petroleum derivatives.

However, the use of fuel cells, particularly in automobiles, has been limited by the unavailability of hydrogen-generating systems which are compact, able to generate hydrogen gas when and where it is to be used, and mechanically simple.

Compactness is particularly desirable if transportability of the fuel cell in combination with the hydrogen source is desired. An example of such an application is a fuel cell powered vehicle having the capacity for on-board generation of hydrogen gas.

Furthermore, it is also desirable that the hydrogen supply have the ability to generate pure hydrogen when and where it is needed. This quality makes a compact structure more realizable in that hydrogen gas can be generated from relatively compact reactants. It also eliminates the extra costs and safety hazards associated with the storage and transportation of hydrogen gas. One alternative is the transportation of large amounts of hydrogen gas with the fuel cell, either in bulk at low pressures, or compressed into containers with thick, heavy walls. However, the hazards of transporting hydrogen are compounded at higher pressures. The second alternative is the storage of large amounts of hydrogen gas at “fueling stations.” However, the large volumes required to store bulk hydrogen gas, or, alternatively, the hazards or storing compressed gas, are as applicable to fueling stations as to the mobile application elucidated above.

Moreover, there is a need for a source of pure hydrogen that is readily transportable. Thus, it is desirable to obtain a system for producing and purifying hydrogen which has a reduced complexity and does not contain an abundance of sensitive moving parts which could be damaged by the shocks encountered during transportation. Such a characteristic would increase the suitability of fuel cell technology for use in automobiles.

In addition, a system which has the additional capacity to produce pure hydrogen at high pressures for high-pressure applications such as fuel stations would greatly improve the applicability of fuel cell technology. Such an ability would be particularly valuable in applications involving the storage in or consumption of fuel from high pressure storage spaces. One example of such an application is a fuel cell-powered vehicle which does not generate its own fuel on board. Another example is a fueling station, as mentioned above. In order to charge vehicle fuel tanks with enough fuel to power the vehicle over appreciable distances, the fueling station would need the ability to discharge gas at high pressures.

However, it has heretofore been expensive and relatively unsafe to produce pure hydrogen gas at the pressures required by practical applications of fuel cell technology. Current methods of producing highly pure, highly pressurized hydrogen generally do not produce and separate hydrogen while creating and retaining the separated gas at high-pressure. Instead, the hydrogen is pressurized only after separation, or gas generation occurs at a different place and/or time than gas separation. The additional cost of compressing hydrogen after purification, as well as the hazard of storing or transporting compressed, high-pressure hydrogen or large volumes of low pressure hydrogen, is such that the use of hydrogen gas fuel cell technology is often not an economically realistic alternative to the use of fossil fuels and other environmentally degrading sources of energy.

### BRIEF SUMMARY OF THE INVENTION

A compact, portable system which can generate and purify hydrogen when and where it is needed is disclosed. The system generates and separates hydrogen gas from mixtures which additionally contain other gases, supercritical fluids, or liquids. Furthermore, the system can also separate hydrogen from high pressure mixtures of gases, supercritical fluids, or liquids, as well as produce pure, high-pressure hydrogen. Such a system can eliminate the need to 1) separate the gas at low pressures and subsequently compress it, or 2) transport or store high-pressure hydrogen between generation and separation.

Accordingly, the inventive method separates hydrogen gas from a reaction mixture by:

a) generating, in a reaction zone, hydrogen gas, in the presence of, or concomitantly with, one or more other gases, liquids or supercritical fluids, to form a mixture which includes hydrogen gas; and

b) separating at least some of said hydrogen gas from said mixture in a separation zone which is selectively hydrogen permeable, whereby said hydrogen gas is separated from the other gases liquids or supercritical fluids which may be present in said mixture. The method as described above is also effective in cases in which the mixture is a high-pressure mixture.

The separation of hydrogen gas is preferably carried out with a separation apparatus, which includes a sieve, preferably a metal membrane, which is selectively permeable to hydrogen gas. The inventive system produces purified hydrogen gas by contacting the output of said hydrogen generator with said sieve. The sieve is preferably of a non-porous metal having very high hydrogen permeability. The system has relatively few parts, and none of them are required to move to effect the production of pure, high-pressure hydrogen. Such a system has a robustness which enables safe, easy transportability and generation of hydrogen when and where desired.

Some methods of generating hydrogen gas are particularly suitable for use with a high-pressure separation or purification system. For example, it may be necessary to generate the gas at temperatures and pressures such that some of the liquid constituents of the reaction mixture join the gaseous phase of the reaction as supercritical fluids and thus must be separated efficiently from the high-pressure hydrogen. Provided is an effective method for separating hydrogen from a high pressure mixture which contains a supercritical fluid. Thus, the present invention provides a method for the separation or purification of hydrogen gas, wherein the method involves a) generating, in a reaction zone, hydrogen, in the presence of or concomitantly with, a supercritical fluid, to form a high pressure mixture of at least hydrogen gas and a supercritical fluid; and b) introducing that high-pressure mixture into a separation zone. The separation zone effectively separates the hydrogen from the high-pressure mixture whereby pure, high-pressure hydrogen can be collected on the downstream side of said separation zone.

An example is the formation of hydrogen gas by oxidation of metals and materials such as sodium metal or sodium hydride in water. The temperatures and pressures that are conducive to the hydrogen formation reaction may also cause the resulting aqueous metal hydroxide solution to be present as a supercritical fluid. The present invention, in one embodiment, is a method for separating hydrogen from the high pressure gas/supercritical fluid mixture formed by the oxidation of sodium metal or sodium hydride by water. The temperatures and pressures typically used produce a mixture which contains hydrogen and a sodium hydroxide supercritical fluid. The method involves a) generating, in a reaction zone, a high-pressure mixture containing at least hydrogen gas and supercritical aqueous alkali metal hydroxide solution; and b) contacting said mixture with a hydrogen permeable metal membrane.

It is important to note that the presence of supercritical fluids or liquids generally causes the reactor vessel to experience an actual pressure which is higher than the pressure exerted by any of the gases which occupy the containing space simultaneously with the supercritical fluid. Thus, as used above and throughout, the term “pressure,” when referring to the reaction zone and not modified by the term “partial,” includes the total pressure exerted by the gases, supercritical fluids and liquids present in the reaction zone.

Generally, the hydrogen permeability of metals used as membranes is dependent on the temperature of the metal. Thus, the present invention controls the diffusion of hydrogen gas from a first zone to a second zone, i.e., a collection zone for collecting pure, hydrogen. The method involves:

a) a reaction which generates hydrogen gas, in a reaction zone, in the presence of, or concomitantly with, one or more other gases, liquids or supercritical fluids to form a mixture containing hydrogen gas; and

b) contacting said mixture with a metal membrane having selective hydrogen permeability, and varying the temperature of the metal membrane; wherein the partial pressure of hydrogen in the reaction zone is higher than the pressure of hydrogen in the collection zone.

If it is desirable to produce high-pressure hydrogen, the hydrogen separation system of the present invention is preferably used in conjunction with a hydrogen-producing reaction that is not appreciably slowed by the accumulation of hydrogen gas to high pressures in spaces which are in diffusive contact with the space occupied by the reactants. By “diffusive contact,” it is meant that hydrogen can pass into the space occupied by the reactants, any barriers between or in the spaces being hydrogen permeable. Thus, the invention provides a method for pressurizing a container to high pressures with pure hydrogen gas. The method involves a) generating hydrogen gas in a reaction zone, in the presence of, or concomitantly with, one or more other gases, liquids or supercritical fluids to form a high-pressure mixture containing hydrogen gas; wherein the rate at which hydrogen gas is evolved is not significantly diminished by the accumulation of hydrogen to high pressures in the reaction zone. The method further includes providing a separation means which has at least one hydrogen permeable metal membrane; disposing the membrane between the space occupied by the reactants and the closed collection space, such that both spaces are completely bounded, but in diffusive communication with respect to hydrogen; and charging said closed collection space to pressures greater than about 10 atmospheres, or more preferably, 100 atmospheres with hydrogen emitted from the surface of the membrane. The hydrogen partial pressure on the upstream side of said membrane is greater than the hydrogen pressure in said closed collection space. Examples of reactions which can continue to evolve hydrogen gas at an appreciable rate under high hydrogen gas pressures are the oxidations of sodium metal and sodium hydride by water.

### DETAILED DESCRIPTION OF THE INVENTION

Hydrogen-forming reactions of the present invention produce hydrogen in the presence of, or concomitantly with, a supercritical, non-hydrogen component which mixes with the hydrogen in the reaction zone. Examples of such reactions are 1) the oxidations of alkali metals and their hydrides in water to produce an aqueous hydroxide byproduct, and 2) the reaction of aluminum metal with sodium hydroxide to produce hydrogen and a sodium aluminate solution. In both-cases, the aqueous metal hydroxide solution may, at reaction temperatures and pressures, result in hydrogen which is mixed with supercritical aqueous sodium hydroxide solution. Other hydrogen-forming reactions which produce hydrogen in the presence of, or concomitantly with, other gases include 1) the reaction of calcium sulfate with hydrochloric acid to give sulfur and hydrogen, and 2) the reaction of steam and ammonia gas to give nitrogen and hydrogen. The use of a hydrogen permeable sieve efficiently separates hydrogen from mixtures such as those formed in the above reactions

A particularly preferred hydrogen-forming reaction is the oxidation with water, of reactants which are Group I or Group II metals or their hydrides, their aluminum hydrides and borohydrides. Suitable metals include alkali metals such as sodium, potassium and lithium, as well as alloys of these metals, including the sodium/potassium alloy commercially known as “NaK.” Suitable metal hydrides include alkali metal hydrides such as lithium hydride, sodium hydride, potassium hydride, and the like. Suitable aluminum hydrides and borohydrides include lithium aluminum hydride, sodium aluminum hydride, and sodium borohydride.

Sodium and sodium hydride may be among the most suitable of the metals and metal hydrides for the generation of large quantities of hydrogen gas because of their cost and availability. In general, the metal hydrides generate more hydrogen gas per molecule than the corresponding metal. Thus, the oxidation of sodium hydride is particularly suitable due to efficiency of hydrogen generation, availability and cost.

In some applications of the invention, the compactness of the hydrogen generating system is an important consideration. In such applications, lithium hydride, sodium borohydride and sodium aluminum hydride may be preferred because they generate relatively high amounts of hydrogen per unit of space occupied by reactants in comparison to other metal or metal hydride reactants.

The term “high-pressure,” as used herein and below, means pressures which are greater than about 10 atmospheres, preferably greater than about 100 atmospheres, ands most preferably greater than about 400 atmospheres.

If the invention is not going to be used in an application requiring the generation of high-pressure hydrogen, it is permissible to employ a hydrogen generating reaction which is hindered by the accumulation of high partial pressures of hydrogen in the reaction zone. However, if the invention is to be used as a source of high-pressure hydrogen, the hydrogen-producing reactions are preferably reactions which can continue to generate hydrogen at a useful rate, unimpeded by the accumulation of high pressure hydrogen gas product at appreciably high pressures in the reaction zone.

Among the reactions which are most suitable for the generation of pure high-pressure hydrogen are the oxidations of alkali metals and alkali metal hydrides by water. The hydrogen-producing reaction is preferably the oxidation of sodium metal or sodium hydride with water.

In general, the oxidation of the above mentioned metals, metal alloys, and metal hydrides in water proceed vigorously to completion at a wide range of temperatures. Thus, reaction rate control, which can be accomplished by, among other things, controlling the rate at which the reactants are contacted, is generally advisable.

Though it is preferable to use pure water, it is permissible to use additives which perform functions such as controlling the rate of the oxidation reaction or changing the properties of the water to better suit the reaction conditions. As an example of the latter, it is permissible to employ additives that cause the water to be a liquid at reaction temperatures and pressures, rather than a supercritical fluid.

The reactants can be mutually contacted in various ways. It may be convenient to add a reactive metal or metal hydride as a solid to liquid water. An example of such a mode of reactant contact is the addition of metal particles or chunks to water. Reactant contact by this mode has the advantage in that reaction control is relatively easy to accomplish. For example, the metal can be divided into pieces which are relatively small and highly uniform in size such that steady addition of the metal by weight gives a uniform reaction rate and a relatively steady production of hydrogen gas. If desired, the metal can be sliced off of a bulk supply in measured amounts at a measured rate, or advanced into the reaction zone as a wire. It may be convenient to encapsulate the metal or metal hydride in a carrier such as a polymer wire or polymer tube, and feed the encapsulated material into the reaction zone at a controlled rate. The rate at which the reactant is bared from its encapsulant coating can be varied by choice of encapsulant. If desired, the encapsulant can be partially or fully dissolved to bare the reactant, or the encapsulated reactant can be mechanically divided into smaller portions, increasing the amount of reactant exposed to the water. If long periods of reaction are desired, it is preferable to select an encapsulant which, when dissolved or divided into smaller pieces, does not appreciably affect the rate of reaction or cause deposits on the reactor surfaces.

Alternatively, molten reactive metal and water can be combined in the reactor as liquids, with input jets, for example, whose outputs come into contact after leaving the jets. It may be convenient to disperse the molten reactive metal using the water as a dispersant. The size of the molten reactive metal droplets can be controlled by adjusting the turbulence of mixing as well as the ratio of water to reactive metal in the mixture. If the pressures and temperatures under which the reaction is occurring permit, the water can be present as ice when contacted by the reactant, which can itself be in solid or liquid form at the time of contact. If desired, the heat of oxidation of the reactant can be utilized to aid in melting the ice which will improve reactant contact and thus further enable the oxidation reaction.

If either or both reactants are to be dispersed prior to being combined, it may be desirable to employ an additive to aid in the dispersal of the reactant. Additives which do not hinder the reaction from ultimately building up a high pressure mixture comprising hydrogen gas are permissible. Preferably, the additive affects the reaction rate only minimally, if at all. Either or both reactants can be mixed with an additive

Preferably, the reactant is added as a solid to water. The water is preferably a supercritical fluid, a liquid, or a gas. The solid reactant can be added in relatively large pieces or as a finely divided powder. It can be added in a single large quantity, or it can be contacted with the water in a controlled manner in order to better control the oxidation reaction.

In particular, the reactant can be added as a jacketed pellet, types of which are described in U.S. Pat. No. 5,728,464, and 5,817,157, which are incorporated herein by reference. The jacket maintains the separation between the reactant and the water. When it is desirable to initiate the oxidation reaction, the jacket is broken, penetrated or removed, allowing the reactant and the water to come into contact. Some suitable materials for the jacket are polymers such as polyethylene, polyvinyl chloride, and polyvinyl acetate. The means for breaching the jacket can be mechanical, such as a single blade; a blade and a means for immobilization while cutting; a scissor-type system of opposing blades; or a system which squashes the pellet and simultaneously rips the jacket. The means for breaching the jacket may also be chemical, such as, among other things, dissolving or melting. Polyvinyl chloride is particularly advantageous as a coating in that it has a relatively high water solubility which facilitates jacket removal by dissolution

The present invention provides, among other things, a method and a system for separating hydrogen gas from high-pressure gas/supercritical fluid mixtures. As such, it is preferable that the hydrogen forming reaction take place in a substantially closed container or reactor. By substantially closed, it is meant that high pressures as elucidated above can develop. Thus, a container in which the products of the hydrogen-forming reaction which is pressurizing the container accumulate faster than they can escape will develop high pressure conditions, and is “substantially closed.” In particular, an example of a substantially closed container is a closed space which is at least partially bounded by one or more hydrogen permeable surfaces into which the products of a hydrogen gas forming reaction are vented such that high pressures can accumulate.

The present system provides, among other things, a method for charging a collection container to high pressures with pure hydrogen gas. When charging a substantially closed container to high pressures with hydrogen gas using the method of the present invention, the location of the hydrogen gas forming reaction can be either inside or outside the container being charged. In either case, the reaction must take place inside its own substantially closed, isolated reaction chamber. If the reaction container is also inside the vessel being charged, the reaction container must emit only substantially pure hydrogen, a more stringent requirement than merely “substantially closed.”

The present invention provides for a system which produces pure, high-pressure hydrogen gas. Such a system is capable of charging closed containers to high pressures with pure hydrogen gas. The high pressures which build up inside the substantially closed space in which the oxidation reaction takes place are preferably above about 10 atmospheres, more preferably, above 100 atmospheres, and most preferably above 400 atmospheres.

The present invention provides for a separation apparatus comprised of a metal membrane which enables the separation of hydrogen gas from high-pressure gas/supercritical fluid mixtures. The metal which gives optimum performance depends upon the specific hydrogen forming reaction employed because the hydrogen permeability of metals having such a property changes with temperature. For example, if the metal is not externally cooled or heated, it will tend toward the temperature of the reaction products which contact it or pass through it. Thus, if neither the metal nor the reaction products are to be heated or cooled (except for heat evolved in the hydrogen gas formation reaction) it is preferable, when selecting a metal, to consider the temperature at which the reaction is run as well as the temperature of the reaction products.

While most metals have some degree of hydrogen permeability, the membrane is preferably made from one or more one of the following metals: palladium, tantalum, vanadium, niobium, yttrium, thorium, zirconium or titanium. The foregoing metals generally have suitable hydrogen permeabilities at temperatures which do not require extreme temperature regulation when used with most hydrogen-forming reactions. An alloy of the foregoing metals, or of one or more of the foregoing metals and one or more non-hydrogen permeable metals can be used if desired, provided the alloy has sufficient hydrogen permeability. In general, it is preferable to avoid alloys and fashion the membrane out of one of the above-mentioned hydrogen-permeable metals. If the oxidation of sodium or potassium is used as the hydrogen forming reaction, the metal is more preferably palladium, tantalum, vanadium or niobium. If the hydrogen reaction is the oxidation of sodium by water, most preferably, the metal is palladium or niobium. If palladium or niobium is used, the temperature of the reactants, the membrane, or both are preferably regulated such that the membrane is in the range of from about 273 K and about 900 K.

The metal membrane provided by the present invention is able to withstand high pressures without its mechanical integrity or filtering capacity being compromised. Its required thickness is dependent on its mechanical structure, among other things. For example, a curved piece of a given thickness which contacts the products of the reaction on the surface area of its convex side need not be as thick as a flat plate of comparable surface area. The membrane need not be of uniform thickness. The membrane may be shaped such that its thickness and shape in some locations on its surface is different than at other locations. For example, if desirable, the membrane can be tubular or have tubular sections, such as a section which extends into the hydrogen gas collection vessel. A structure with a small bore and a high surface area, such as a long, relatively thin tubular structure, fashioned into a coil or other space-conserving configuration is an efficient structure for use as a membrane. Such a structure can withstand relatively high pressures with a minimum usage of metal. Moreover, small surface areas of contact on the inside of the tube are somewhat compensated for by the reduced wall thickness which gives an increased rate of permeation relative to a thicker walled structure.

In general, as the rate of hydrogen diffusion through the membrane is determined by the thickness of the membrane, it is desirable to select a thickness and structure which maximizes the ability of the membrane to withstand pressure, yet allows it to pass hydrogen gas at an appreciable rate.

The hydrogen flux passed by the membrane is a function of the metal identity, metal thickness, metal temperature, and the hydrogen pressure differential across the membrane.

The Hydrogen Permeability, P* is defined by the flux equation:

Flux (vol/s/cm²)=−P*(√P₁−√P₂)/δ (1)

where P₁ and P₂ are the reaction zone and collection zone hydrogen pressures, respectively and δ of the metal foil. The permeability is defined as:

P*=Pₒ exp(−Qₚ/R_{g}T) (2)

where absolute temperature, R_{g} is the gas constant, Pₒ is an empirically determined pre exponential factor and Qₚ is a quantity known as the hydrogen permeability activation energy. Both quantities are metal characteristics, and are given in Table I, below. A non-limiting example illustrating the flux of hydrogen for a sample metal, materials, thickness and pressure differential is also given below in Example I.

In general, for a given thickness and shape, membranes which have greater surface areas contacted by the high pressure mixture will withstand smaller pressure differentials before the structural integrity of the membrane is compromised. Details of membrane design which further elucidate the inter-relation of details such as mechanical strength of the membrane metal, metal thickness, radius/radius of curvature of tubular or other curved structures, and maximum pressure tolerance can be found in various books on Structural mechanics, such as Mechanics of Materials: an Introduction to the Mechanics of Elastic and Plastic Deformation of Solids and Structural Components, by E. J. Hearn.

In some cases, it may be desirable or necessary to increase the load-bearing potential of the membrane by internal or external supports. Examples of internal supports are internal regions composed of metals having a greater mechanical strength than the hydrogen-permeable metal portions of the membrane include stainless steel, and other relatively inert metals. Other materials which, when incorporated in the membrane, increase its mechanical strength without causing it to have severely reduced hydrogen permeability can be incorporated. The internal supports may be comprised of other hydrogen-permeable metals having a mechanical strength which is greater than that of the membrane metal.

External supports may be placed on either the reaction mixture side of the membrane or the hydrogen collection side. They may be hydrogen permeable, if desired. If they are to be placed on the surface of the membrane for mechanical support, they need not be of a material of greater mechanical strength than the membrane material in order to add mechanical strength. However, if they are embedded, it is preferable that at least the embedded portion be of a material which has greater mechanical strength than the membrane material.

In general, it is most practical to have a “self supporting area” (area that is bounded by support pieces, but lacking supports which extend into the area or across it) in the range of from about one square micrometer to about one square centimeter, with an average membrane thickness in the range of from about 1 micron to about 10 millimeters. Such areas can generally take pressure differentials in the range of 0.1 atmospheres to about 1000 atmospheres and remain substantially intact, with larger areas withstanding correspondingly smaller pressure differentials. Details of the inter-relationship of parameters such as supported area, mechanical strength of the membrane metal, and metal thickness can be found in various texts on Structural mechanics, such as the above-referenced book, by E. J. Hearn.

One technique for increasing the mechanical strength and thereby, the pressure-bearing capacity of the membrane, is the use of rigid, porous structural support members such as fritted supports to support the membrane. Such supports may be constructed by sintering together particles of metal or other materials into a porous structure. In securing the support against the membrane, supported areas are formed. The use of smaller particles results in correspondingly smaller supported areas. The support can be placed on either side of the membrane, although if it is on the reaction side, it may be necessary to have a prefilter, as discussed below, to protect it from the effects of corrosive reactants or products. The relationship between particle size and supported area size can be found in the above-referenced text by Heam. Particularly with membranes which are essentially metal foils, it is necessary to support the foil with a porous substructure that will not be deformed by the pressure drop and which itself allows the passage of hydrogen. An example of this is the use porous metal frit like that produced by Mott Corporation and described on their web page: http://www.mottcorp.com/media/oem-media.htm.

The relationship between maximum supported area radius (frit pore radius), pressure differential across the metal membrane, tensile strength of the membrane metal, and thickness of the membrane metal is given by the following formula:

Frit Pore Radius=σδ/ΔP, (3)

where σ is the tensile strength of the membrane metal, δ is the thickness of the membrane, and AP is the pressure differential across the membrane. Note that the pressure differential takes into account the total pressure in the reaction zone, not simply the hydrogen partial pressure. See Example II, below.

It may be convenient to join the membrane and the rest of the separation means at a substantially pressure-tight seal, with the pressure-tightness of the seal increasing with increasing pressure differential across the membrane from the reaction zone side to the hydrogen collection side.

The metal membrane may be subject to degradation or coating by reactants or products which could hinder the membrane's functional efficiency. Thus it may be desirable to use a prefilter to prevent certain reactants or non-hydrogen products from coming into contact with the membrane. Examples of such prefilters are polymer filters. For example, if the hydrogen producing reaction is the reduction of sodium with water, a polymer filter can prevent supercritical fluid-phase sodium hydroxide solution formed during the reaction from contacting and corroding the membrane. Such filters must also have a high enough hydrogen permeability such that the evolution and separation of hydrogen is relatively unimpeded.

In general, the choice of prefilter design and material should be such that the prefilter has the ability to withstand pressure differentials which arise in the course of the hydrogen-forming reaction, whether caused by gases or supercritical fluid-phase reactants or products. For example, if a prefilter is used in conjunction with the reduction of sodium, the prefilter should have the mechanical strength to tolerate the pressure differential between the supercritical phase of the aqueous sodium hydroxide on the reaction side and the pressure of the substantially pure hydrogen on the separation zone side of the filter. If the prefilter has relatively low hydrogen permeability, or the hydrogen is evolved rapidly, the reaction side will reach even higher pressures, requiring a correspondingly increased prefilter strength. Furthermore, if the high-pressure system is used in an application in which the hydrogen pressure drop on the collection side of the prefilter causes the hydrogen pressure between the prefilter and the metal membrane to drop at a rate exceeds the rate at which hydrogen passes through the membrane, the prefilter should generally have the ability to maintain its structural integrity.

TABLE I
Permeability Pre Exponential Factor, Pₒ, and Activation Energy, Qₚ.

| Material | Pₒ(cm³(STP)/s/cm/atm^{1/2} | Qₚ (kcal/mole) |
|---|---|---|
| Metals | | |
| Ni¹ | 1.2 × 10⁻³ | 13.85 |
| Cu¹ | 1.5-2.3 × 10⁻⁴ | 16 to 18.7 |
| α-Fe¹ | 2.9 × 10⁻³ | 8.4 |
| Al¹ | 3.3-4.2 × 10⁻¹ | 30.8 |
| Pd² | 1.5 × 10⁻² | 3.63 |
| Ta² | 1.3 × 10⁻³ | −3.02 |
| Y² | 3.0 × 10⁻⁴ | −6.26 |
| Nb² | 3.6 × 10⁻⁴ | −6.86 |

¹Geiger, G.H. and Poirier, D.R., “Transport Phenomena in Metallurgy,” Addison-Wesley Publishing Company, Reading Ma, 1973, p. 476.
²Analysis of data taken from http://www.rebresearch.com/H2perm2.htm

### EXAMPLE I

Pd metal foil 1 mm thick operating as a Hydrogen gas membrane at 25° C. with a reaction zone pressure, P₁, of 6500 psi (442 atm) and a collection zone pressure, P₂, of 6000 psi (408 atm). If temperature, T is 298K, the Pd permeability is 3.117×10⁻⁵ cm³(STP)/s/cm/√atm. By equation 1, the flux is 2.57×10⁻⁴ cm³(STP)/s/cm². To deliver 2.57 cm³ of Hydrogen at standard temperature and pressure (STP) per second, 1 m² of area of the Pd foil is required. In addition, it is possible to reduce the surface needed by decreasing the foil thickness according to equation 1. By decreasing the foil thickness from 1 mm to 0.01 mm, the 1 m² area will be able to deliver 257 cm³ of Hydrogen at STP per sec.

### EXAMPLE II

A rough calculation of the maximum pore radius allowable such that supported areas in 316 stainless steel will have sufficient strength to support a pressure drop, ΔP, of 500 psi, from Example I above. Pores in the structure which have larger radii will mechanically tear due to the pressure drop across the foil. Pore radius is determined by using the ultimate tensile strength of the Pd³ which has a value of 180 MPa (σ) and equation 3. When the thickness of the foil, δ, is 0.01 mm thick, the pores in the porous metal frit should be less than about 522 microns in order to avoid tearing due to the pressure differential.

What is claimed is:

1. A method for producing hydrogen gas from a mixture comprising hydrogen gas, said method comprising:
generating, in a reaction zone, hydrogen gas, in the presence of, or concomitantly with, one or more other gases, liquids or supercritical fluids, to form a mixture comprised of hydrogen gas; and
separating at least some of said hydrogen gas from said mixture in a separation zone having selective hydrogen permeability, whereby the separated hydrogen gas is substantially pure.

2. The method as in claim 1 wherein a collection zone collects said substantially pure hydrogen gas from said separation zone.

3. The method of claim 1 wherein said mixture in said reaction zone has a total pressure in said reaction zone which is greater than about 10 atmospheres.

4. The method of claim 1 wherein said mixture in said reaction zone has a total pressure which is greater than about 100 atmospheres.

5. The methods of claim 1, wherein said mixture is filtered such that at least one non-hydrogen component of said mixture is substantially separated from said mixture before said mixture is introduced into said separation zone.

6. The methods of claim 1, wherein said mixture comprising hydrogen gas is generated by the oxidation of one or more Group I metals, Group II metals, Group I metal hydrides, Group I metal aluminum hydrides, Group I metal borohydrides, Group II metal hydrides, Group II metal aluminum hydrides and Group II metal borohydrides with water.

7. The methods of claim 1 wherein said mixture comprising hydrogen gas is generated by the oxidation of one or more of the following with water: sodium metal, sodium hydride, sodium aluminum hydride, sodium borohydride, lithium metal, lithium hydride and lithium borohydride.

8. The methods of claim 3 wherein said mixture comprising hydrogen gas is generated by the oxidation of one or more of the following with water: sodium aluminum hydride, sodium borohydride, and lithium hydride.

9. The methods of claim 3 wherein said mixture comprises the gaseous, liquid and supercritical fluid products of the oxidation of sodium metal or sodium hydride by water.

10. The method of claim 3 wherein said collection zone contains substantially pure hydrogen at a pressure greater than about 10 atmospheres.

11. The method of claim 4 wherein said collection zone contains substantially pure hydrogen and said collection zone is at a pressure greater than about 100 atmospheres.

12. A system for the generation of pure hydrogen gas which comprises a source which generates a mixture of hydrogen gas and at least one other gas, liquid or supercritical fluid; and a separation means comprising a selectively hydrogen-permeable sieve which is contacted by said mixture on its upstream side, and which yields substantially pure hydrogen gas on its downstream side.

13. The system of claim 12 wherein said sieve comprises a metal membrane having selective hydrogen permeability.

14. The system of claim 13 wherein said metal membrane is made of one or more of the following metals: palladium, tantalum, vanadium, niobium, yttrium, thorium, zirconium or titanium.

15. The system of claim 13 wherein said membrane is substantially pure palladium, yttrium, tantalum or niobium.

16. The system of claim 15 wherein said mixture has a pressure against said membrane which is greater than about 100 atmospheres.

17. The system of claim 15, wherein said membrane is supported by a rigid porous structural support member.

18. The system of claim 14, wherein said membrane is contacted by a rigid porous structural support member which is in contact with said membrane on its downstream side.

19. The system of claim 16 wherein said membrane comprises a tubular member having an opening communicating with said mixture, and a closed end.

20. The system of claim 19 wherein said tubular member has an average diameter in the range of from about 0.01 mm to about 10 cm, and a length in the range of from about 1 cm up to about a kilometer.

21. The system of claim 18 wherein the average supported area over the membrane contacted by the rigid porous structural support member is in the range of from about 1 square micrometer to about 1 square centimeter.

22. The system of claim 21 wherein the temperature of the membrane is less than about 1000 K.

23. The system of claim 21 wherein the membrane interfaces with the remainder of the separation means in a substantially pressure-tight seal, the pressure-tightness of said seal increasing with pressure at pressures up to about 700 atmospheres.

24. The system of claim 13 wherein the mixture contacts a polymer prefilter prior to contacting the membrane.

25. The system of claim 13 wherein the mixture comprises the gaseous, liquid and supercritical fluid products of the oxidation one or more Group I metals, Group II metals, Group I metal hydrides, Group I metal aluminum hydrides, Group I metal borohydrides, Group II metal hydrides, Group II metal aluminum hydrides and Group II metal borohydrides with water

26. The system of claim 13 wherein the mixture comprises the gaseous, liquid and supercritical fluid products of the oxidation of sodium metal, sodium hydride, sodium aluminum hydride, sodium borohydride, lithium metal, lithium hydride and lithium borohydride.

27. The system of claim 13 wherein the mixture comprises the gaseous, liquid and supercritical fluid products of the oxidation of sodium aluminum hydride, sodium borohydride, and lithium hydride.
